(19) United States
(12) Patent Application Publication
(10) Pub. No.: US 2012/0062055 A1
(43) Pub. Date: Mar. 15, 2012

(54) COOLING STRUCTURE FOR ROTATING ELECTRIC MACHINE

(75) Inventors: Satoshi MURAKAMI, Nishio (JP); Yukinori NAKAMORI, Okazaki (JP)

(73) Assignee: AISIN AW CO., LTD., Anjo-shi (JP)

(21) Appl. No.: 13/211,706

(22) Filed: Aug. 17, 2011

(30) Foreign Application Priority Data
Sep. 14, 2010 (JP) 2010-205391

(51) Int. Cl. H02K 9/19

(52) U.S. Cl. 310/54

(57) ABSTRACT

A cooling structure for a rotating electric machine, having a coolant supply portion, and configured to supply a coolant to a coil end portion of a stator. A protrusion portion is provided on a portion of a coil end facing area, and projects toward the coil end portion side and extends downward and toward a radially inner side of the coil end portion, wherein the coil end facing area is a section that faces the coil end portion on an inner wall surface of a case that accommodates the stator. A collection portion collects the coolant distributed along the protrusion portion. A drip portion is disposed on the radially inner side of the coil end portion at a position that axially overlaps with the coil end portion as viewed from the radial direction, wherein the coolant collected in the collection portion drips from the drip portion.

### INCORPORATION BY REFERENCE

The disclosure of Japanese Patent Application No. 2010-205391 filed on Sep. 14, 2010 including the specification, drawings and abstract is incorporated herein by reference in its entirety.

### BACKGROUND OF THE INVENTION

The present invention relates to a cooling structure for a rotating electric machine in which a stator includes a coil.

1. Description of the Related Art

A rotating electric machine used in the past includes a stator having coils, and a rotor having permanent magnets. In this type of rotating electric machine, the coils and the permanent magnets generate a large amount of heat depending on the output. If the heat generated by the coils becomes excessive, there may be an insulation breakdown of insulating varnish that insulates conductors forming the coils from each other, and insulating paper that insulates coils of each phase from each other. Therefore, cooling of the coils is desired. Technology for this purpose includes art described in Japanese Patent Application Publication Nos. JP-A-2003-336725 and JP-A-2009-136070 below.

A drive unit for a hydraulic generating device described in JP-A-2003-336725 cools a coil by supplying oil discharged from a pump through an oil supply pipe and a sub supply pipe to a stator core and a coil end portion. A stator cooling structure described in JP-A-2009-136070 cools a coil by supplying cooling oil discharged from a pump through an oil cooling path to a stator core and a coil end portion.

According to such art as described in JP-A-2003-336725 and JP-A-2009-136070, the stator core and the coil end portion are cooled by the transmission of heat to coolant, which is supplied to the stator core and the coil end portion and falls to the surface of the stator core and the coil end portion by the force of gravity. Therefore, if a large amount of heat is generated by the coils, the amount of coolant supplied for maintaining a cooling effect must be increased.

### SUMMARY OF THE INVENTION

In the art described in JP-A-2003-336725 and JP-A-2009-136070, when the amount of coolant supplied is increased in line with the amount of heat generated by the coils, the coolant flow rate also increases. Consequently, the coolant supplied to the coil end portion of the stator strikes the coil end portion and scatters, which means that the coolant falls away before heat exchange occurs between the coil end portion and the coolant. The amount of coolant supplied is therefore not necessarily the amount of coolant falling by the force of gravity to the coil end portion, thus resulting in reduced cooling efficiency. Further, heat exchange at an upper region of the coil end portion in the vertical direction, which is a region to which the coolant is supplied, is promoted in proportion to the increase in the amount of coolant supplied. However, heat exchange at a relatively lower region in the vertical direction is not promoted in proportion to the supply amount, and variations in temperature tend to occur at the coil end portion.

In view of the foregoing, it is desirable to achieve a cooling structure for a rotating electric machine that can suitably cool a coil end portion without a reduction in cooling efficiency, regardless of a supply amount of coolant.

According to a first aspect of the present invention, a cooling structure for a rotating electric machine includes: a coolant supply portion that is disposed more vertically upward than an axial center of a rotor shaft, and supplies a coolant to a coil end portion of a stator; a protrusion portion that is provided on a portion of a coil end facing area, and projects toward the coil end portion side and extends downward and toward a radially inner side of the coil end portion, wherein the coil end facing area is a section that faces the coil end portion on an inner wall surface of a case that accommodates the stator; a collection portion that collects the coolant distributed along the protrusion portion; and a drip portion that is disposed on the radially inner side of the coil end portion at a position that axially overlaps with the coil end portion as viewed from the radial direction, wherein the coolant collected in the collection portion drips from the drip portion.

Note that in the present application, the “rotary electric machine” is used as a concept that includes any one of a motor (electric motor), a generator (electric generator), and a motor/generator that carries out both the functions of a motor and a generator as necessary. Further, “overlapping” as viewed from a certain direction with respect to the arrangement of two members refers to the fact that, when using that certain direction as a line of sight and moving a viewpoint to each direction perpendicular to that line of sight, there exists a viewpoint at which the two members appear to overlap in at least some regions.

According to the first aspect, even if the coolant supplied to the coil end portion rebounds and scatters, the coolant is distributed along the protrusion portion that is provided on the coil end facing region that faces the coil end portion and can be collected in the collection portion.

In addition, because the drip portion is disposed at a position that axially overlaps with the coil end portion as viewed from the radial direction, the coolant collected in the collection portion can drip to and suitably cool the coil end portion that is located more vertically downward than the rotor shaft. Thus, according to the present invention, the scattered coolant that was supplied to the coil end portion can also be used for cooling of the coil end portion. Therefore, regardless of the amount of coolant supplied from the coolant supply portion, there is no reduction in cooling efficiency and the coil end portion can be suitably cooled.

According to a second aspect of the present invention, the protrusion portion may be provided in the coil end facing area as more vertically upward than the axial center of the rotor shaft.

According to the second aspect, because the protrusion portion is provided in the coil end facing area as more vertically upward than the axial center of the rotor shaft, the coolant that strikes the coil end portion and then rebounds and scatters can be efficiently gathered and collected in the collection portion.

According to a third aspect of the present invention, the protrusion portion may extend radially inward from a position on the inner wall surface that is more radially outward than the coil end portion.

According to the third aspect, even if the coolant supplied to the coil end portion rebounds and then scatters radially outward from the coil end portion, the coolant can be suitably distributed toward the collection portion and collected in the collection portion.

According to a fourth aspect of the present invention, the protrusion portion may be formed in a plurality, and all radial inner ends of the plurality of protrusion portions may be located within a vertically upward area of the collection portion.

According to the fourth aspect, after distribution along the protrusion portion, the coolant that falls by the force of gravity can be easily collected by the collection portion. Accordingly, the coolant can be collected and utilized without wasting any coolant, thus increasing cooling efficiency.

According to a fifth aspect of the present invention, the plurality of protrusion portions may be arranged in a radial configuration centered on the rotor shaft.

According to the fifth aspect, the coolant distributed along the protrusion portion can be easily gathered at one location. Accordingly, the coolant can be collected and utilized without wasting any coolant, thus increasing cooling efficiency,

According to a sixth aspect of the present invention, the collection portion may be disposed on the radially inner side of the coil end portion at a position that axially overlaps with the coil end portion as viewed from the radial direction, and a lowermost portion of the collection portion may be provided with a drip path serving as the drip portion.

According to the sixth aspect, the coolant collected in the collection portion can drip from the drip path to the coil end portion that is more vertically downward than the rotor shaft. Accordingly, even in a configuration that supplies coolant from above the coil end portion, a section on a lower side of the coil end portion in the vertical direction can be cooled. Thus, variations in the temperature of the coil end portion can be suppressed.

According to a seventh aspect of the present invention, a cylindrical support projecting portion that axially projects around the rotor shaft and supports a bearing of the rotor shaft from a radially outer side may be provided on the inner wall surface. Also, the collection portion may include an outer circumferential surface of the support projecting portion, and a collection projecting portion that projects in the axial direction and extends upward and radially outward from the outer circumferential surface of the support projecting portion.

According to the seventh aspect, the support projecting portion for supporting the bearing of the rotor shaft can be utilized to configure the collection portion. Therefore, the collection portion can be easily provided on the radially inner side of the coil end portion.

According to an eighth aspect of the present invention, a lid member that covers a space over the collection projecting portion from a side opposite the inner wall surface may be attached by contacting at least a portion of an axial end surface of the collection projecting portion.

According to the eighth aspect, the coolant can be accumulated above the collection portion, and a relatively large amount of coolant can be suitably supplied to the drip portion.

### BRIEF DESCRIPTION OF THE DRAWINGS

FIG. 1 is a cross-sectional view of a rotating electric machine to which a cooling structure for a rotating electric machine according to a first embodiment is applied;

FIG. 2 is a frontal view of a cover according to the first embodiment;

FIG. 3 is a perspective view of the cover according to the first embodiment;

FIG. 4 is a cross-sectional view of the rotating electric machine to which the cooling structure for a rotating electric machine according to a second embodiment is applied;

FIG. 5 is a frontal view of the cover according to the second embodiment; and

FIG. 6 is a perspective view of the cover according to the second embodiment.

### DETAILED DESCRIPTION OF THE EMBODIMENTS

A cooling structure for a rotating electric machine according to the present invention (referred to as a “cooling structure” below) is constituted so as to be capable of collecting coolant that is supplied to a coil end portion from above the coil end portion, and supplying the collected coolant to a lower side of the coil end portion in the vertical direction as well. This cooling structure will be described below using the drawings.

### 1. First Embodiment

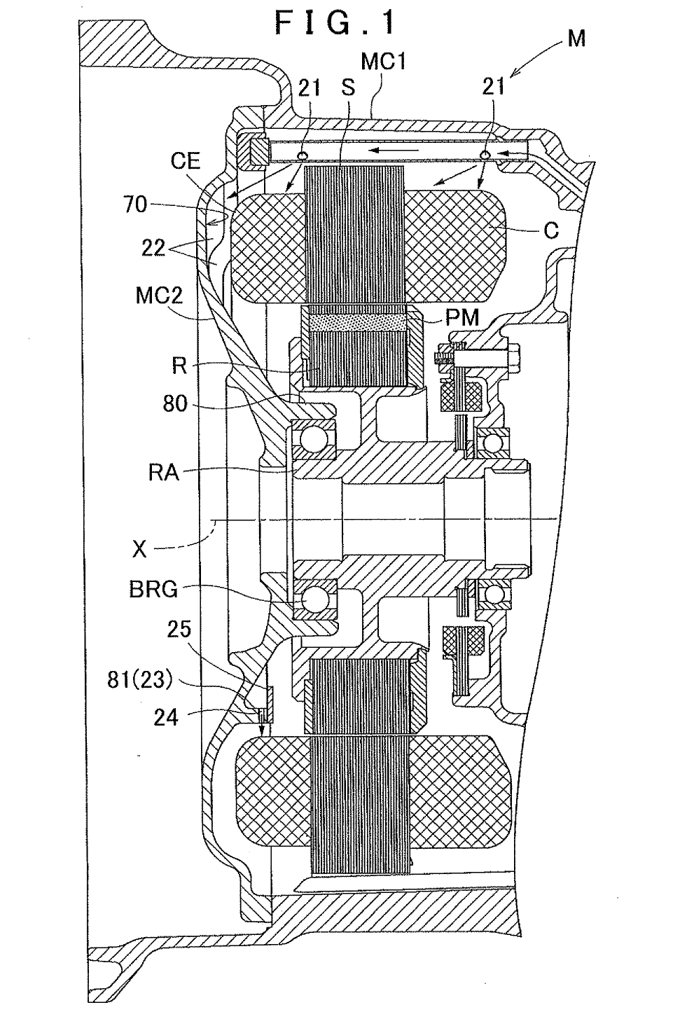

FIG. 1 shows a cross-sectional view of a rotating electric machine M to which the cooling structure according to the present embodiment is applied. As shown in FIG. 1, the rotating electric machine M is constituted such that a stator S and a rotor R are accommodated inside a space that is formed by a case body MC1 and a cover MC2 that covers an opening portion of the case body MC1. The stator S is fixed to the case body MC1.

The rotating electric machine M may output the driving force (rotary force) generated by the rotating electric machine M to outside the rotating electric machine M. In such case, the rotating electric machine M functions as an electric motor. By transmitting a driving force (rotary force) to the rotating electric machine M from outside, the rotating electric machine M may also function as a generator that generates power. The present embodiment will be described using an example in which the rotating electric machine M functions as an electric motor.

The rotating electric machine M functioning as an electric motor acquires rotary power through the electromagnetic action of a coil C and a permanent magnet PM. Acquisition of such rotary power is a known art and will not be described further here. In the present embodiment, the coil C is provided in the stator S, and the permanent magnet PM is provided in the rotor R.

More current flows through the coil C as the load of the rotating electric motor M increases. Therefore, the coil C heats up from Joule heat. In order to cool the coil C, the rotating electric motor M is provided with the cooling structure according to the present invention. The cooling structure includes a coolant supply portion 21, a protrusion portion 22, a collection portion 23, a drip portion 24, and a lid member 25.

The coolant supply portion 21 is disposed more vertically upward than an axial center X of a rotor shaft RA, and supplies coolant to a coil end portion CE of the stator S. The rotor shaft RA is a rotating shaft that is included on the radially inner side of the rotor R. In the present embodiment, the coolant supply portion 21 is disposed on the radially outer side of the stator S, that is, the vertically upper side of the stator 5, which is positioned more vertically upward than the rotor shaft RA. Further, in the present embodiment, the coolant supply portion 21 is disposed at two positions along the rotor axial direction. Thus, the coolant discharged from the coolant supply portion 21 is supplied to the coil end portion CE by the force of gravity.

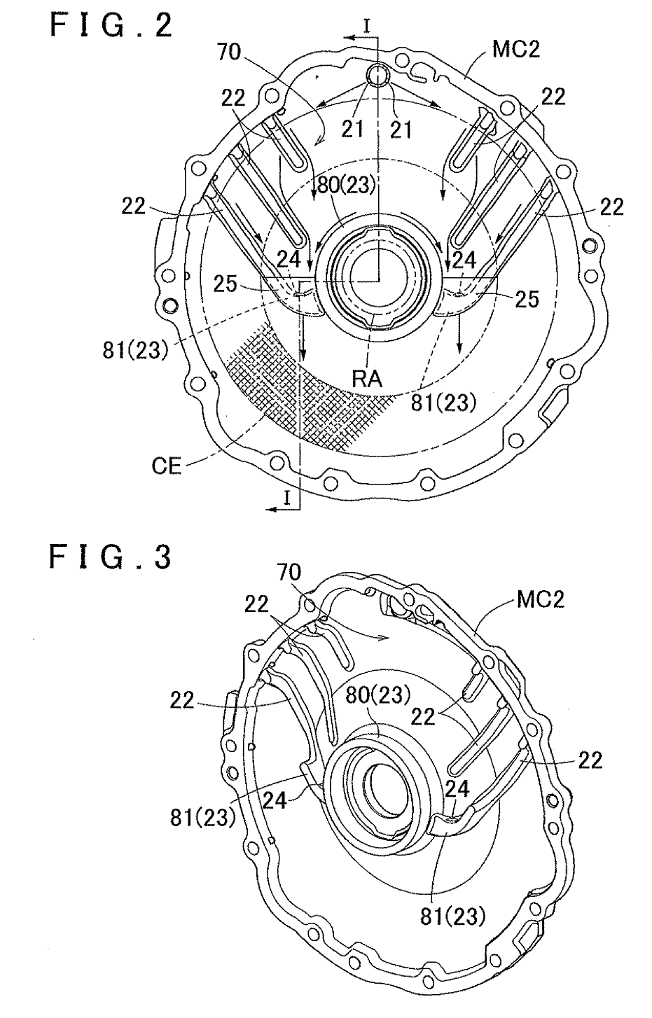

Here, FIG. 2 shows a frontal view of the cover MC2 according to the present embodiment. Note that FIG. 1 corresponds to a cross-sectional view taken along a line I-I in FIG. 2. FIG. 3 shows a perspective view of the cover MC2 according to the present embodiment. The protrusion portion 22 projects toward the coil end portion CE side and is provided on a portion of a coil end facing area 70, which is a section that faces the coil end portion CE on the inner wall surface of the case (cover) MC2 that accommodates the stator S. The coil end facing area 70 is the inner wall surface of the cover MC2 that faces the coil end portion CE from a predetermined distance. The protrusion portion 22 is provided in the coil end facing area 70 so as to project toward the coil end portion CE side.

The protrusion portion 22 is provided more vertically upward than the axial center X of the rotor shaft RA in the coil end facing area 70. Accordingly, the coolant more vertically upward than the axial center X of the rotor shaft RA is distributed along the protrusion portion 22.

In addition, the protrusion portion 22 is constituted so as to extend downward and toward the radially inner side of the coil end portion CE. As shown in FIGS. 2 and 3, there is a plurality of protrusion portions 22 formed. The plurality of protrusion portions 22 is arranged in a radial configuration centered on the rotor shaft RA. The radial configuration is not limited to a configuration in which the protrusion portions 22 are all arranged on radiating lines that extend radially outward from the axial center X of the rotor shaft RA, and simply refers to a state in which the protrusion portions 22 are all arranged so as to connect the radially inner and outer sides of the coil end portion CE. Accordingly, the radial configuration also includes a state in which the protrusion portion 22 is disposed away from the radiating line.

Radially outer ends of the plurality of protrusion portions 22 are all provided in contact with a circumferential wall portion of the cover MC2. The radially outer end is an end portion of the protrusion portion 22 on the radially outer side. Accordingly, the protrusion portion 22 is configured so as to extend radially inward from a position on the inner wall surface that is more radially outward than the coil end portion CE. Thus, the coolant discharged from the coolant supply portion 21 that strikes the coil end portion CE and scatters is surely collected by the protrusion portion 22, and can be distributed along the protrusion portion 22.

Further, radially inner ends of the plurality of protrusion portions 22 are all arranged so as to be located at positions within an area vertically above the collection portion 23 described later. The radially inner end is an end portion of the protrusion portion 22 on the radially inner side. The area vertically above the collection portion 23 is an area located vertically overhead with respect to the collection portion 23, and an area whose position overlaps with the collection portion 23 as viewed from vertically above. Accordingly, the collection portion 23 is disposed vertically below the radially inner ends of all the protrusion portions 22. Therefore, the coolant that is distributed along the protrusion portion 22 and falls from the radially inner end, which is a lower end of the protrusion portion 22, is collected by the collection portion 23.

Here, the inner wall surface of the cover MC2 is provided with a cylindrical support projecting portion 80 that axially projects around the rotor shaft RA, and supports a bearing BRG of the rotor shaft RA from the radially outer side. Axially projecting around the rotor shaft RA refers to a state in which the support projecting portion 80 projects in the axial direction so as to surround the radially outer side of the rotor shaft RA. The bearing BRG is provided between the outer circumferential surface of the rotor shaft RA and the radially inner surface of the support projecting portion 80 thus projecting. Therefore, the rotor shaft RA is rotatably supported relative to the cover MC2.

The collection portion 23 is configured to include the outer circumferential surface of the support projecting portion 80 and a collection projecting portion 81. The outer circumferential surface of the support projecting portion 80 is a surface that faces radially outward among the surfaces on the support projecting portion 80 that is shaped as a cylinder. The collection projecting portion 81 is a section that projects in the axial direction and extends upward and radially outward from the outer circumferential surface of the support projecting portion 80. Here, the collection projecting portion 81 is disposed with the support projecting portion 80 therebetween and widens toward both radial sides. In the present embodiment, a plurality of protrusion portions 22 is provided as described above. Here, the collection projecting portion 81 is integratedly formed with part of the plurality of protrusion portions 22. More specifically, a radially outer end portion of the collection projecting portion 81 is connected and integrated to a radially inner end portion of the protrusion portion 22 that is disposed most vertically downward in the cover MC2 among the plurality of protrusion portions 22.

The collection portion 23 is also disposed on the radially inner side of the coil end portion CE at a position that axially overlaps with the coil end portion CE as viewed from the radial direction. In other words, a state is achieved in which, on the radially inner side of the coil end portion CE, the collection portion 23 and the coil end portion CE at least partially include sections that are at the same position with respect to their arrangement in the axial direction. Accordingly, as described later, the coolant can be supplied to the coil end portion CE located below the drip portion 24 by simply dripping the coolant from the drip portion 24 provided in the collection portion 23.

Here, as shown in FIG. 3, the radially inner end of the most vertically downward protrusion portion 22 is connected to and integratedly formed with the collection projecting portion 81. Meanwhile, the radially inner end of the protrusion portion 22 that is not most vertically downward is provided separated vertically upward from the support projecting portion 80 and the collection projecting portion 81. The projecting height of each protrusion portion 22 in the axial direction (i.e., an axial height) decreases in a stepped fashion from the radially outer end toward the radially inner end. The most vertically downward protrusion portion 22 described above is provided connected to the collection projecting portion 81, and the projecting height of the collection projecting portion 81 is formed higher than the projecting height of the radially inner end of the protrusion portion 22 so as to form a step.

The lid member 25 is provided so as to cover a space over the collection projecting portion 81 from a side opposite the inner wall surface. Here, the side opposite the inner wall surface is the rotor R side of the collection projecting portion 81. The space over the collection projecting portion 81 is a space vertically upward of the collection projecting portion 81, and corresponds to a space that is partitioned by the inner wall surface, the collection projecting portion 81, and the outer circumferential surface of the support projecting portion 80. The lid member 25 is attached by contacting at least a portion of an axial end surface of the collection projecting portion 81 so as to cover this space. In other words, at least a portion of the space described above is partitioned by the lid member 25 from a side facing the inner wall surface. Thus, the coolant distributing along the protrusion portion 22 can be accumulated to a predetermined amount in the collection portion 23.

The drip portion 24 is disposed on the radially inner side of the coil end portion CE at a position that axially overlaps with the coil end portion CE as viewed from the radial direction, and the coolant collected in the collection portion 23 drips from the drip portion 24. In other words, a state is achieved in which the drip portion 24 is disposed on the radially inner side of the coil end portion CE, and the drip portion 24 and the coil end portion CE at least partially include sections that are at the same position with respect to their arrangement in the axial direction. From the drip portion 24, the coolant collected in the collection portion 23 drips onto the coil end portion CE that is located below the drip portion 24.

In the present embodiment, a drip path serving as the drip portion 24 is disposed on a lowermost portion of the collection portion 23. The drip path is assigned with the reference numeral 24 in the description below. The drip path 24 is a communication path that communicates the space over the collection projecting portion 81 described above to the vertically lower side of the collection projecting portion 81. In this example, the drip path 24 is provided in the collection projecting portion 81 along the vertical direction. Therefore, it is possible to discharge the coolant collected by the collection portion 23 in the vertically downward direction, and the coolant can be supplied to the coil end portion CE that is vertically downward. This in turn enables cooling of the coil end portion CE that is located more vertically downward than the rotor shaft RA. It should be noted that, in the example shown in the drawings, the drip portion 24 (drip path) is a through-hole that runs through the collection projecting portion 81. Here, the drip portion 24 (drip path) may also be configured by a groove that is provided on a surface of the collection projecting portion 81 that is on the side opposite the inner wall surface.

Thus, according to the present cooling structure, even if the coolant supplied from the coolant supply portion 21 strikes the coil end portion CE and then rebounds and scatters, the coolant is distributed along the protrusion portion 22 that is provided on the coil end facing area 70 that faces the coil end portion CE and can be collected in the collection portion 23.

In addition, because the drip portion 24 is disposed at a position that axially overlaps with the coil end portion CE as viewed from the radial direction, the coolant collected in the collection portion 23 can drip to and suitably cool the coil end portion CE that is located more vertically downward than the rotor shaft RA. Thus, according to the present cooling structure, the scattered coolant that was supplied to the coil end portion CE can also be used for cooling of the coil end portion CE. Therefore, regardless of the amount of coolant supplied from the coolant supply portion 21, there is no reduction in cooling efficiency and the coil end portion CE can be suitably cooled.

### 2. Second Embodiment

A second embodiment of the present invention will be explained next. In the above description of the first embodiment, the collection projecting portion 81 is configured so as to extend upward and radially outward from the outer circumferential surface of the support projecting portion 80. However, the collection portion 23 according to the present embodiment differs from the first embodiment in that the collection portion 23 is configured as separate from the support projecting portion 80. Also, in the above description of the first embodiment, part of the plurality of protrusion portions 22 is provided as connected to the collection projecting portion 81. However, the protrusion portion 22 according to the present embodiment differs from the first embodiment in that the protrusion portions 22 are all provided as separate from the collection projecting portion 23. The following description will focus on points where the protrusion portion 22 and the collection portion 23 according to the present embodiment differ from those of the first embodiment. Note that aspects not described in particular detail are similar to those of the first embodiment.

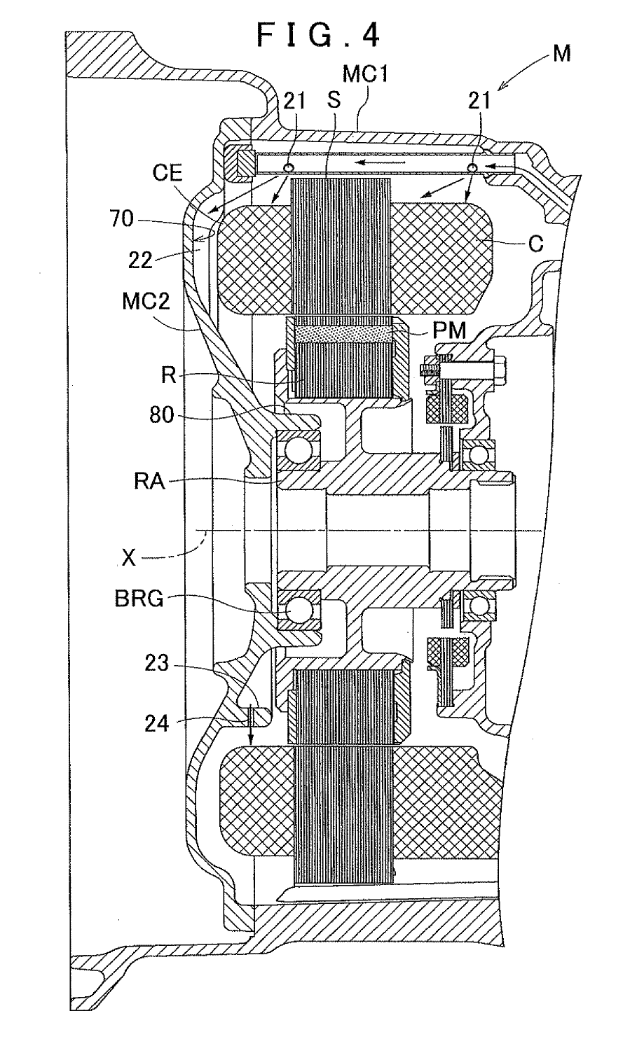

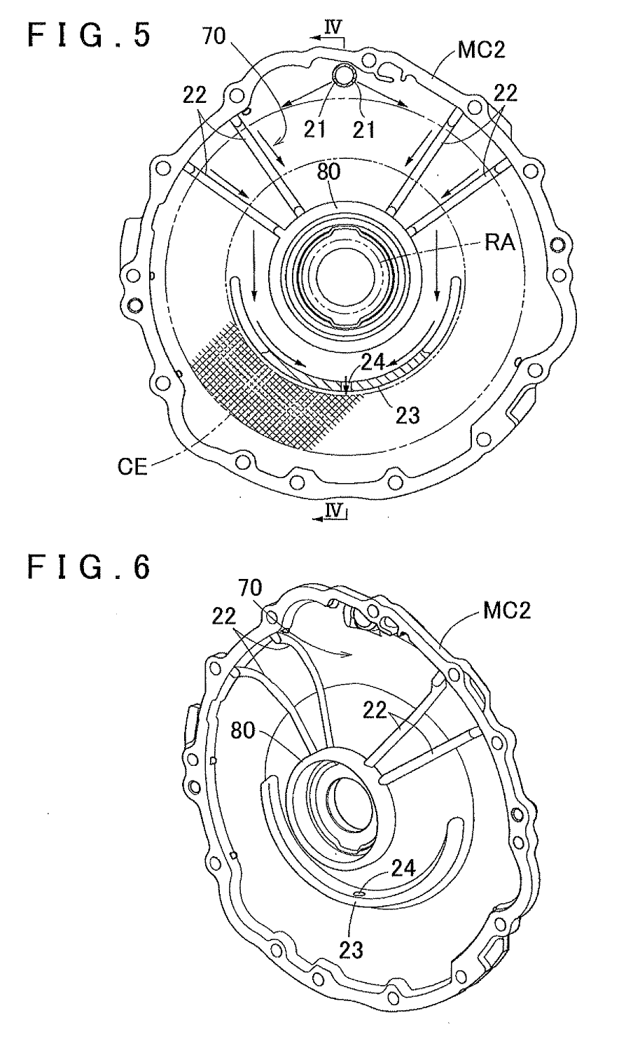

FIG. 4 is a cross-sectional view of the rotating electric machine M to which the cooling structure according to the present embodiment is applied. FIG. 5 is a frontal view of the case cover MC2 according to the present embodiment. Note that FIG. 4 corresponds to a cross-sectional view taken along a line IV-IV in FIG. 5. FIG. 6 is a perspective view of the cover MC2 according to the present embodiment. As shown in FIGS. 4 to 6, a plurality of protrusion portions 22 according to the present embodiment is formed, similar to the first embodiment described above. In the present example, the plurality of protrusion portions 22 is arranged on radiating lines that extend radially outward from the axial center X of the rotor shaft RA. The radially inner ends of the plurality of protrusion portions 22 are all provided in contact with the outer circumferential surface of the support projecting portion 80. Accordingly, the coolant supplied from the coolant supply portion 21 and distributed along the protrusion portion 22 is distributed up to the support projecting portion 80. The coolant distributed to the support projecting portion 80 falls to the collection portion 23 by the force of gravity and is collected therein.

The collection portion 23 is provided so as to project toward the coil end portion CE side in the axial direction from the inner wall surface of the case cover MC2. The collection portion 23 is also disposed on the radially inner side of the coil end portion CE so as to axially overlap with the coil end portion CE as viewed from the radial direction. In the present embodiment, the collection portion 23 is formed with an arc configuration that extends along the circumferential direction in at least an area more vertically downward than the axial center X of the rotor shaft RA, as shown in FIGS. 5 and 6.

The drip path 24 is provided on the lowermost portion of the collection portion 23. The drip path 24 is provided along the vertical direction. Thus, the coolant collected by the collection portion 23 can fall by the force of gravity and be supplied to the coil end portion CE that is located vertically downward of the rotor shaft RA. Accordingly, the coil end portion CE can be suitably cooled.

### 3. Other Embodiments

Other embodiment of the present invention will be explained next. It should be noted that the constitution of each embodiment described herein is not limited to being applied in an individual manner, and may be applied in combination with the constitution of other embodiments unless an inconsistency occurs.

(1) In the embodiments described above, the protrusion portion 22 is provided more vertically upward than the axial center X of the rotor shaft RA in the coil end facing area 70. However, the scope of the present invention is not limited to this example. As another example, obviously, the protrusion portion 22 may also be provided more vertically downward than the axial center X of the rotor shaft RA in the coil end facing area 70. In addition, obviously, the protrusion portion 22 may be provided more vertically downward than the axial center X of the rotor shaft RA so long as the protrusion portion 22 is disposed such that the coolant can flow toward the collection portion 23. In such case, the scattered coolant is also distributed along the protrusion portion 22, and the coolant can naturally be supplied from the collection portion 23 to the coil end portion CE through the drip portion 24.

(2) In the embodiments described above, the protrusion portion 22 extends radially inward from a position on the inner wall surface that is more radially outward than the coil end portion CE. However, the scope of the present invention is not limited to this example. Obviously, the protrusion portion 22 may also be configured so as to extend toward the radially inner side from a position on the inner wall surface that is more toward the radially inner side than the coil end portion CE. In such case, the coolant can naturally still be distributed along the protrusion portion 22.

(3) In the embodiments described above, a plurality of protrusion portions 22 is formed. However, the scope of the present invention is not limited to this example. A configuration that uses only one protrusion portion 22 is also possible. In such case, the coolant can still be suitably distributed to the protrusion portion. FIG. 2 shows six protrusion portions 22, and FIG. 5 shows four protrusion portions 22. However, these are merely illustrative examples, and a configuration that uses any other number of protrusion portions 22 is obviously possible. There is also no need to arrange the protrusion portions 22 symmetrical about the axial center X of the rotor shaft RA.

(4) In the embodiments described above, the radially inner ends of the plurality of protrusion portions 22 are all located within an area vertically above the collection portion 23. However, the scope of the present invention is not limited to this example. Any configuration is possible provided that the radially inner end of the protrusion portion 22 is arranged at a position that at least overlaps with the adjacent protrusion portion 22 below as viewed from the vertical direction. With such a configuration, the coolant that is distributed to the radially inner end of the protrusion portion 22 can fall to the adjacent protrusion portion 22 below. Accordingly, the coolant can be suitably collected in the collection portion 23 so long as only the radially inner end of the vertically lowermost protrusion portion 22 is located within the vertically upward area of the collection portion 23.

(5) In the embodiments described above, the plurality of protrusion portions 22 is arranged in a radial configuration centered on the rotor shaft RA. However, the scope of the present invention is not limited to this example. Obviously, the plurality of protrusion portions 22 may be arranged in a configuration other than a radial configuration.

(6) In the embodiments described above, the collection portion 23 is disposed on the radially inner side of the coil end portion CE at a position that axially overlaps with the coil end portion CE as viewed from the radial direction, and a drip path serving as the drip portion 24 is provided at the lowermost portion of the collection portion 23. However, the scope of the present invention is not limited to this example. Any configuration is possible provided that the drip portion 24 is at least disposed on the radially inner side of the coil end portion CE at a position that axially overlaps with the coil end portion CE as viewed from the radial direction, and the collection portion 23 may be disposed at a position different from those in the embodiments described above. In addition, the drip portion 24 may obviously be provided at a position other than the lowermost portion of the collection portion 23.

(7) In the embodiments described above, the lid member 25 is attached by contacting at least a portion of the axial end surface of the collection projecting portion 81 from a side opposite the inner wall surface. However, the scope of the present invention is not limited to this example. As another example, a configuration is possible in which the lid member 25 is not included in the first embodiment, and a configuration in which the lid member 25 is included in the second embodiment is also naturally possible.

(8) In the embodiments described above, the drip portion 24 (drip path) is a through-hole that runs through the collection protruding portion 81. In addition, the drip portion 24 (drip path) may also be configured by a groove that is provided on a surface of the collection protruding portion 81 that is on the side opposite the inner wall surface. However, the scope of the present invention is not limited to this example. In other words, the drip portion 24 may also be configured without provided a through-hole or a groove. In such case, a region at which the coolant collected in the collection portion 23 overflows from the collection portion 23 corresponds to the “drip portion” according to the present invention. Of course, as described above, if the lid member 25 is included on at least a portion of the axial end surface of the collection projecting portion 81 from a side opposite the inner wall surface, the region at which the coolant overflows from the lid member 25 corresponds to the “drip portion” according to the present invention. Alternatively, if the lid member 25 as described above is not included, the lowermost portion of the collection projecting portion 81 is the drip portion. The cooling structure for the rotating electric machine M that includes the drip portion 24 that does not have a through-hole or a groove as described is within the scope of the present invention.

The present invention can be utilized as a cooling structure for a rotating electric machine in which a stator includes a coil.

What is claimed is:

1. A cooling structure for a rotating electric machine, comprising:
a coolant supply portion that is disposed more vertically upward than an axial center of a rotor shaft, and supplies a coolant to a coil end portion of a stator;
a protrusion portion that is provided on a portion of a coil end facing area, and projects toward the coil end portion side and extends downward and toward a radially inner side of the coil end portion, wherein the coil end facing area is a section that faces the coil end portion on an inner wall surface of a case that accommodates the stator;
a collection portion that collects the coolant distributed along the protrusion portion; and
a drip portion that is disposed on the radially inner side of the coil end portion at a position that axially overlaps with the coil end portion as viewed from the radial direction, wherein the coolant collected in the collection portion drips from the drip portion.

2. The cooling structure for a rotating electric machine according to claim 1, wherein
the protrusion portion is provided in the coil end facing area as more vertically upward than the axial center of the rotor shaft.

3. The cooling structure for a rotating electric machine according to claim 2, wherein
the protrusion portion extends radially inward from a position on the inner wall surface that is more radially outward than the coil end portion.

4. The cooling structure for a rotating electric machine according to claims 3, wherein
the protrusion portion is formed in a plurality, and all radial inner ends of the plurality of protrusion portions are located within a vertically upward area of the collection portion.

5. The cooling structure for a rotating electric machine according to claim 4, wherein
the plurality of protrusion portions is arranged in a radial configuration centered on the rotor shaft.

6. The cooling structure for a rotating electric machine according to claims 5, wherein
the collection portion is disposed on the radially inner side of the coil end portion at a position that axially overlaps with the coil end portion as viewed from the radial direction, and a lowermost portion of the collection portion is provided with a drip path serving as the drip portion.

7. The cooling structure for a rotating electric machine according to claims 6, wherein
a cylindrical support projecting portion that axially projects around the rotor shaft and supports a bearing of the rotor shaft from a radially outer side is provided on the inner wall surface, and
the collection portion includes an outer circumferential surface of the support projecting portion, and a collection projecting portion that projects in the axial direction and extends upward and radially outward from the outer circumferential surface of the support projecting portion.

8. The cooling structure for a rotating electric machine according to claim 7, wherein
a lid member that covers a space over the collection projecting portion from a side opposite the inner wall surface is attached by contacting at least a portion of an axial end surface of the collection projecting portion.

9. The cooling structure for a rotating electric machine according to claim 1, wherein
the protrusion portion extends radially inward from a position on the inner wall surface that is more radially outward than the coil end portion.

10. The cooling structure for a rotating electric machine according to claims 9, wherein
the protrusion portion is formed in a plurality, and all radial inner ends of the plurality of protrusion portions are located within a vertically upward area of the collection portion.

11. The cooling structure for a rotating electric machine according to claim 10, wherein
the plurality of protrusion portions is arranged in a radial configuration centered on the rotor shaft.

12. The cooling structure for a rotating electric machine according to claims 11, wherein
the collection portion is disposed on the radially inner side of the coil end portion at a position that axially overlaps with the coil end portion as viewed from the radial direction, and a lowermost portion of the collection portion is provided with a drip path serving as the drip portion.

13. The cooling structure for a rotating electric machine according to claims 12, wherein
a cylindrical support projecting portion that axially projects around the rotor shaft and supports a bearing of the rotor shaft from a radially outer side is provided on the inner wall surface, and
the collection portion includes an outer circumferential surface of the support projecting portion, and a collection projecting portion that projects in the axial direction and extends upward and radially outward from the outer circumferential surface of the support projecting portion.

14. The cooling structure for a rotating electric machine according to claim 13, wherein
a lid member that covers a space over the collection projecting portion from a side opposite the inner wall surface is attached by contacting at least a portion of an axial end surface of the collection projecting portion.

15. The cooling structure for a rotating electric machine according to claims 1, wherein
the protrusion portion is formed in a plurality, and all radial inner ends of the plurality of protrusion portions are located within a vertically upward area of the collection portion

16. The cooling structure for a rotating electric machine according to claim 15, wherein
the plurality of protrusion portions is arranged in a radial configuration centered on the rotor shaft.

17. The cooling structure for a rotating electric machine according to claims 16, wherein
the collection portion is disposed on the radially inner side of the coil end portion at a position that axially overlaps with the coil end portion as viewed from the radial direction, and a lowermost portion of the collection portion is provided with a drip path serving as the drip portion.

18. The cooling structure for a rotating electric machine according to claims 17, wherein
a cylindrical support projecting portion that axially projects around the rotor shaft and supports a bearing of the rotor shaft from a radially outer side is provided on the inner wall surface, and
the collection portion includes an outer circumferential surface of the support projecting portion, and a collection projecting portion that projects in the axial direction and extends upward and radially outward from the outer circumferential surface of the support projecting portion.

19. The cooling structure for a rotating electric machine according to claim 18, wherein
a lid member that covers a space over the collection projecting portion from a side opposite the inner wall surface is attached by contacting at least a portion of an axial end surface of the collection projecting portion.

20. The cooling structure for a rotating electric machine according to claims 1, wherein
the collection portion is disposed on the radially inner side of the coil end portion at a position that axially overlaps with the coil end portion as viewed from the radial direction, and a lowermost portion of the collection portion is provided with a drip path serving as the drip portion.

21. The cooling structure for a rotating electric machine according to claims 20, wherein
a cylindrical support projecting portion that axially projects around the rotor shaft and supports a bearing of the rotor shaft from a radially outer side is provided on the inner wall surface, and
the collection portion includes an outer circumferential surface of the support projecting portion, and a collection projecting portion that projects in the axial direction and extends upward and radially outward from the outer circumferential surface of the support projecting portion.

22. The cooling structure for a rotating electric machine according to claim 21, wherein
a lid member that covers a space over the collection projecting portion from a side opposite the inner wall surface is attached by contacting at least a portion of an axial end surface of the collection projecting portion.

23. The cooling structure for a rotating electric machine according to claims 1, wherein
a cylindrical support projecting portion that axially projects around the rotor shaft and supports a bearing of the rotor shaft from a radially outer side is provided on the inner wall surface, and
the collection portion includes an outer circumferential surface of the support projecting portion, and a collection projecting portion that projects in the axial direction and extends upward and radially outward from the outer circumferential surface of the support projecting portion.

24. The cooling structure for a rotating electric machine according to claim 23, wherein
a lid member that covers a space over the collection projecting portion from a side opposite the inner wall surface is attached by contacting at least a portion of an axial end surface of the collection projecting portion.
